(19) United States
(12) Patent Application Publication
(10) Pub. No.: US 2026/0082164 A1
(43) Pub. Date: Mar. 19, 2026

(54) NOISE REDUCTION FOLLOWED BY WIDE DYNAMIC RANGE COMPRESSION IN EAR-WORN DEVICES

(71) Applicant: Fortell Research Inc., New York, NY (US)

(72) Inventors: Ivo MERKS, Eden Prairie, MN (US); Nicholas Morris, Brooklyn, NY (US)

(21) Appl. No.: 19/331,280

(22) Filed: Sep. 17, 2025

Related U.S. Application Data
(60) Provisional application No. 63/696,025, filed on Sep. 18, 2024.

(51) Int. Cl. H04R 25/00; G10L 25/78; G10L 25/84

(52) U.S. Cl. CPC H04R 25/507; G10L 25/84; G10L 2025/783; H04R 2225/43; H04R 2430/01

(57) ABSTRACT

Disclosed herein is wide dynamic range compression (WDRC) circuitry that may be configured to determine a WDRC gain based on a level of an input audio signal and apply the WDRC gain to an enhanced audio signal generated using neural network circuitry. In some embodiments, WDRC circuitry may include speech level calculation circuitry configured to determine a first level, where the first level is calculated based, at least in part, on speech in the input audio signal; level selection circuitry configured to select a level that is the first level if the first level is greater than a threshold level, and a second level, different from the first level, if the first level is not greater than the threshold level; and WDRC gain circuitry configured to determine a WDRC gain based on the level selected by the level selection circuitry.

### BACKGROUND

### Field

The present disclosure relates to ear-worn devices. Some aspects relate to performing noise reduction followed by wide dynamic range compression (WDRC)

### Related Art

Ear-worn devices, such as hearing aids, may be used to help those who have trouble hearing to hear better. Typically, ear-worn devices amplify received sound. Some ear-worn devices may attempt to enhance received sound.

### BRIEF DESCRIPTION OF THE FIGURES

Various aspects and embodiments will be described with reference to the following figures. It should be appreciated that the figures are not necessarily drawn to scale. In the drawings, each identical or nearly identical component that is illustrated in various figures may be represented by a like numeral. For purposes of clarity, not every component may be labeled in every drawing.

FIG. 1 illustrates a view of a hearing aid, in accordance with certain embodiments described herein.

FIG. 2 illustrates circuitry in an ear-worn device, in accordance with certain embodiments described herein.

FIG. 3 illustrates noise reduction circuitry, in accordance with certain embodiments described herein.

FIG. 4 illustrates WDRC circuitry, in accordance with certain embodiments described herein.

FIG. 5 illustrates WDRC circuitry, in accordance with certain embodiments described herein.

FIG. 6 illustrates WDRC circuitry, in accordance with certain embodiments described herein.

FIG. 7 illustrates WDRC circuitry, in accordance with certain embodiments described herein.

FIG. 8 illustrates WDRC circuitry, in accordance with certain embodiments described herein.

FIG. 9 illustrates WDRC circuitry, in accordance with certain embodiments described herein.

FIG. 10 illustrates WDRC circuitry, in accordance with certain embodiments described herein.

FIG. 11 illustrates WDRC circuitry, in accordance with certain embodiments described herein.

FIG. 12 illustrates WDRC circuitry, in accordance with certain embodiments described herein.

### DETAILED DESCRIPTION

Some ear-worn devices such as hearing aids apply a non-linear, frequency-dependent gain to the incoming sound so as to “fit” the output sound to the hearing profile of the wearer. For example, if a wearer has significant hearing loss in higher frequencies and much less hearing loss in lower frequencies, then, for the same input volumes, the ear-worn device may apply more gain to higher frequency sounds than lower frequency sounds. This may help to equalize, in effect, the audibility or perceived loudness of different sounds across frequencies. Additionally, because those with hearing loss typically have a narrow range of volumes at which they can comfortably hear (a reduced “dynamic range”), some ear-worn devices may apply more gain to quiet sounds and less gain to louder sounds, in effect “compressing” the original signal into the dynamic range of the wearer. These techniques are sometimes referred to as wide-dynamic range compression (WDRC).

Recently, technology for using neural networks to separate speech from noise in ear-worn devices has been developed. Further description of such neural networks for reducing noise may be found in U.S. Pat. No. 11,812,225, titled “Method, Apparatus and System for Neural Network Hearing Aid,” issued Nov. 7, 2023, which is incorporated by reference herein in its entirety. Once speech and noise have been separated, such ear-worn devices may output an enhanced audio signal containing just the speech, or the speech plus a reduced amount of noise. The inventors have developed improved methods and circuitry for performing WDRC after noise reduction in ear-worn devices.

The aspects and embodiments described above, as well as additional aspects and embodiments, are described further below. These aspects and/or embodiments may be used individually, all together, or in any combination of two or more, as the disclosure is not limited in this respect.

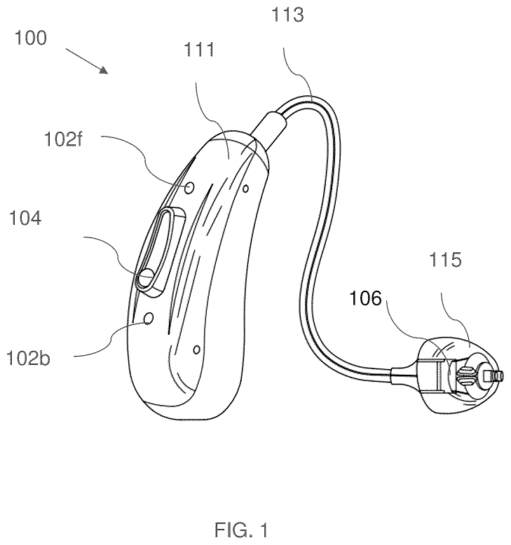

FIG. 1 illustrates a view of a hearing aid 100, in accordance with certain embodiments described herein. The hearing aid 100 may be any of the ear-worn devices or hearing aids described herein. The hearing aid 100 is a receiver-in-canal (RIC) (also referred to as a receiver-in-the-ear (RITE)) type of hearing aid. However, any other type of hearing aids (e.g., behind-the-ear, in-the-ear, in-the-canal, completely-in-canal, open fit, etc.) may also be used. The hearing aid 10 includes a body 111, a receiver wire 113, a receiver 114, and a dome 115. The body 111 is coupled to the receiver wire 113 and the receiver wire 113 is coupled to the receiver 114. The dome 115 is placed over the receiver 114. The body 111 includes a front microphone 102f, a back microphone 102b, and a user input device 104. The body 111 additionally includes circuitry not illustrated in FIG. 1 (e.g., any of the circuitry illustrated hereinafter, aside from the receiver). When the hearing aid 100 is worn, the front microphone 102f may be closer to the front of the wearer and the back microphone 102b may be closer to the back of the wearer. The front microphone 102f and the back microphone 102b may be configured to receive sound signals and generate audio signals based on the sound signals. The user input device 104 (e.g., a button) may be configured to control certain functions of the hearing aid 100, such as volume, activation of neural network-based denoising, etc.

The receiver wire 113 may be configured to transmit audio signals from the body 111 to the receiver 114. The receiver 114 may be configured to receive audio signals (i.e., those audio signals generated by the body 111 and transmitted by the receiver wire 113) and generate sound signals based on the audio signals. The dome 115 may be configured to fit tightly inside the wearer's ear and direct the sound signal produced by the receiver 114 into the ear canal of the wearer.

In some embodiments, the length of the BTE part 111 may be equal to 2 cm, equal to 5 cm, or between 2 and 5 cm in length. In some embodiments, the weight of the hearing aid 100 may be less than 4.5 grams. In some embodiments, the spacing between the microphones may be equal to 5 mm, equal to 12 mm, or between 5 and 12 mm. In some embodiments, the BTE part 111 may include a battery (not visible in FIG. 1), such as a lithium ion rechargeable coin cell battery

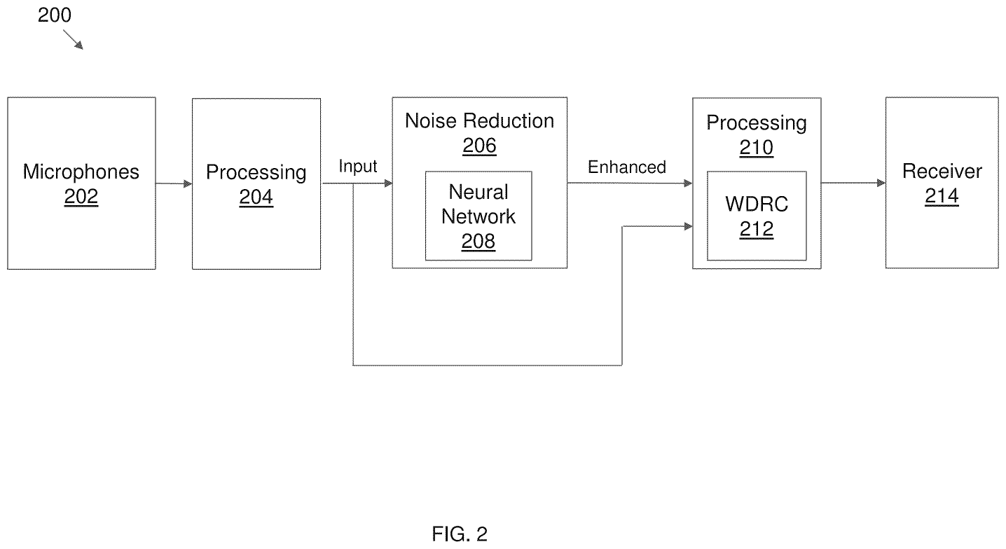

FIG. 2 illustrates circuitry in an ear-worn device 200, in accordance with certain embodiments described herein. The ear-worn device may be, for example, a hearing aid (e.g., the hearing aid 100), a cochlear implant, or an earphone. The ear-worn device 200 includes microphones 202, processing circuitry 204, noise reduction circuitry 206 including neural network circuitry 208, processing circuitry 210 including wide dynamic range compression (WDRC) circuitry 212, and a receiver 214. It should be appreciated that the ear-worn device 200 may include more circuitry and components than shown, and such circuitry and components may be disposed before, after, or between certain of the circuitry and components illustrated in FIG. 2.

The microphones 202 may include one or more (e.g., 1, 2, 3, 4, or more) microphones. For example, the microphones 202 may include two microphones, a front microphone (e.g., the front microphone 102f) that is closer to the front of the wearer of the ear-worn device 200 and a back microphone (e.g., the back microphone 102b) that is closer to the back of the wearer of the ear-worn device 200. The microphones 202 may be configured to receive sound signals and generate audio signals from the sound signals.

In some embodiments, the processing circuitry 204 may include analog processing circuitry. The analog processing circuitry may be configured to perform analog processing on the audio signals received from the microphones 202. For example, the analog processing circuitry may be configured to perform one or more of analog preamplification, analog filtering, and analog-to-digital conversion. As referred to herein, analog processing circuitry may include analog-to-digital conversion circuitry, and an analog-processed signal may be a digital signal that has been converted from analog to digital by analog-to-digital conversion circuitry.

In some embodiments, the processing circuitry 204 may include digital processing circuitry. The digital processing circuitry may be configured to perform digital processing on the analog-processed audio signals. For example, the digital processing circuitry may be configured to perform one or more of wind reduction, input calibration, and anti-feedback processing.

In some embodiments, the processing circuitry 204 may include beamforming circuitry. The beamforming circuitry may be configured to generate one or more beamformed audio signals from two or more of the digital-processed audio signals The beamformed audio signals may include one or more individual signals, each a beamformed version of two or more digital-processed audio signals. In some embodiments, the beamforming circuitry may be configured to generate multiple beamformed audio signals each having a different directional pattern.

The noise reduction circuitry 206 includes the neural network circuitry 208. The neural network circuitry 208 may be configured to implement one or more neural network layers. Any neural network layers described herein may be, for example, of the recurrent, vanilla/feedforward, convolutional, generative adversarial, attention (e.g. transformer), or graphical type. Using one or more outputs from the neural network circuitry 208, the noise reduction circuitry 206 may be configured to perform noise reduction. Thus, as illustrated in FIG. 2, the noise reduction circuitry 206 may be configured to receive an input audio signal (referred to herein as “Input”) including speech and noise, and generate an enhanced audio signal (referred to herein as “Enhanced”) that is a noise-reduced version of Input.

The processing circuitry 210 may be configured to perform further processing on Enhanced. The processing circuitry 210 includes the WDRC circuitry 212, which may be configured to perform WDRC. As illustrated, and as described further below, the processing circuitry 210 may be configured to receive Input and Enhanced. The processing circuitry 210 may be configured to also perform other types of processing, such as output calibration.

The receiver 214 (of which the receiver 114 may be an example) may be configured to play back the output of the processing circuitry 210 as sound into the ear of the user. The receiver 214 may also be configured to implement digital-to-analog conversion prior to the playing back.

In some embodiments, portions of the circuitry in the ear-worn device 200 may be configured to process audio signals in the frequency domain. In such embodiments, the processing circuitry 204 may include short-time Fourier transform (STFT) circuitry configured to convert short windows of audio signals from time domain to frequency domain, and the processing circuitry 210 may include inverse STFT (ISTFT) circuitry configured to convert short windows of audio signals from frequency domain to time domain. In such embodiments, Input and Enhanced may be in the frequency domain. In some embodiments, portions of the circuitry in the ear-worn device 200 may be configured to process audio signals in the time domain. In some embodiments, the ear-worn device may lack STFT and iSTFT circuitry.

Deploying noise reduction techniques may introduce delays between when a sound is emitted by the sound source and when the noise-reduced sound is output to a user. For example, such techniques may introduce a delay between when a speaker speaks and when a listener hears the noise-reduced speech. During in-person communication, long latencies can create the perception of an echo as both the original sound and the noise-reduced version of the sound are played back to the listener. Additionally, long latencies can interfere with how the listener processes incoming sound due to the disconnect between visual cues (e.g., moving lips) and the arrival of the associated sound. To attain tolerable latencies when implementing a neural network on an ear-worn device, the ear-worn device may need to be capable of performing billions of operations per second. To address power issues with such demanding requirements, the neural network circuitry 208 (in addition to other circuitry) may be implemented on a chip in an ear-worn device (e.g., the ear-worn device 200 and/or the hearing aid 100). Thus, in some embodiments, one or more of the processing circuitry 204, the noise reduction circuitry 206 (including the neural network circuitry 208), and the processing circuitry 210 (including the WDRC circuitry 212) may be implemented on a single same chip (i.e., a single semiconductor die or substrate) in the ear-worn device. Further description of chips incorporating (in some embodiments, among other elements) neural network circuitry for use in ear-worn devices may be found in U.S. Pat. No. 11,886,974, entitled “Neural Network Chip for Ear-Worn Device,” issued Jan. 30, 2024, which is incorporated by reference herein in its entirety, as well as below.

Any of the neutral network circuitry described herein (e.g., the neural network circuitry 208) may include circuitry configured to perform operations necessary for computing the output of a neural network layer. One such operation may be a matrix-vector multiplication. In some embodiments, neural network circuitry may include multiple identical tiles on the chip, each including multiple multiply-and-accumulate circuits configured to perform intermediate computations of a matrix-vector multiplication in parallel and then compute results of the intermediate computations into a final result. Each tile may additionally include memory configured to store neural network weights, registers configured to store input activation elements, and routing circuitry configured to facilitate communication of status and data between tiles. Other types of circuitry configured to perform processing described herein, such as any of the mask application and subtraction circuitry (e.g., the mask application and subtraction circuitry 336), noise gain application circuitry (e.g., the noise gain application circuitry 338), stationary noise suppression circuitry (e.g., the stationary noise suppression circuitry 340) may be implemented as digital processing circuitry on the chip. In some embodiments, such digital processing circuitry may use a SIMD (single instruction multiple data) architecture. Thus, the chip may include the tiles and digital processing circuitry described above. In some embodiments, for a model having up to 10M 8-bit weights, and when operating at 100 GOPs/see on time series data, the chip may achieve power efficiency of 4 GOPs/milliwatt, measured at 40 degrees Celsius, when the chip uses supply voltages between 0.5-1.8V, and when the chip is performing operations without idling. In some embodiments, in addition to such a chip, any of the ear-worn devices described herein may include a digital signal processor configured to perform other operations, such as some or all of the processing performed by the processing circuitry 204 and/or processing circuitry 210.

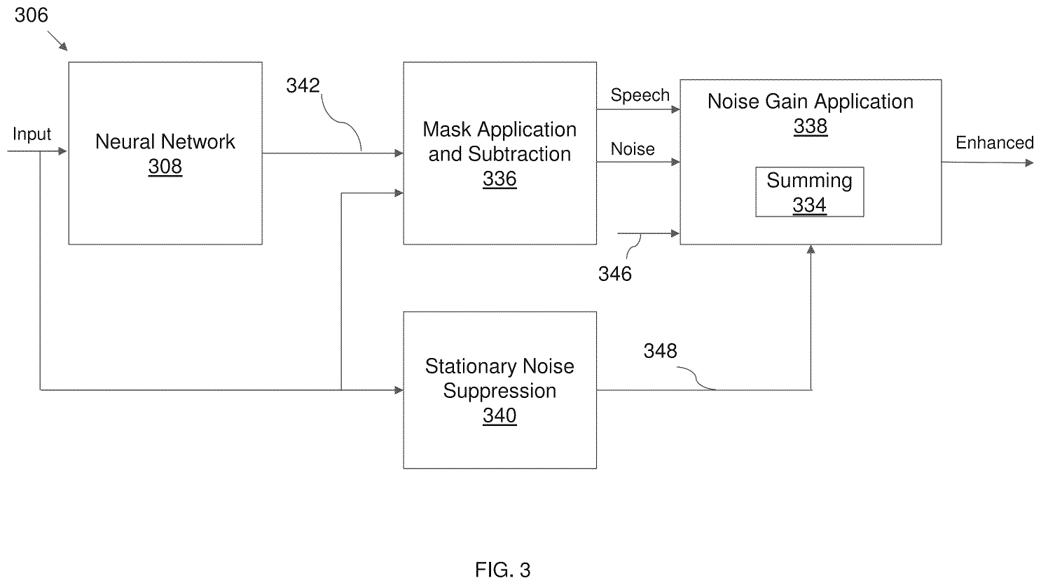

FIG. 3 illustrates noise reduction circuitry 306, in accordance with certain embodiments described herein. The noise reduction circuitry 306 may be an example of the noise reduction circuitry 206. The noise reduction circuitry 306 includes neural network circuitry 308, mask application and subtraction circuitry 336, noise gain application circuitry 338, and stationary noise suppression (SNS) circuitry 340.

The neural network circuitry 308 may be configured to implement a neural network (or generally, one or more neural network layers) trained to perform noise reduction. In particular, the neural network circuitry 308 may be configured to receive Input (and in some embodiments, other audio signals) and use the neural network to generate and output one or more neural network outputs 342 based on Input. As will be described below, the noise reduction circuitry 306 may be configured to generate a noise-reduced version of Input based on the one or more neural network outputs 342.

In some embodiments, one of the one or more neural network outputs may be a mask. The mask may be a real or complex mask that varies with frequency. The mask application and subtraction circuitry 336 may be configured to receive the one or more neural network outputs 342 and output processed outputs. In particular, the mask application and subtraction circuitry 336 may be configured to apply (e.g., with multiplication or addition) the mask to an audio signal, such as Input. In some embodiments, the neural network implemented by the neural network circuitry 308 may be trained to output the mask such that, when the mask application and subtraction circuitry 336 applies the mask to Input (or some other audio signal), just an audio signal (referred to herein as “Speech”) representing the predicted speech component of Input remains. In some embodiments, the neural network implemented by the neural network circuitry 308 may be trained to output the mask such that, when the mask application and subtraction circuitry 336 applies the mask to Input (or some other audio signal), just an audio signal (referred to herein as “Noise”) representing the predicted noise component of Input remains.

In some embodiments, the mask application and subtraction circuitry 336 may be configured to perform one or more subtraction operations (or in some embodiments, other operations such as addition) to generate one or more audio signals from one or more other audio signals. In some embodiments, the mask application and subtraction circuitry 336 may be configured to generate Noise by subtracting Speech (e.g., generated using a mask as described above) from Input. In some embodiments, the mask application and subtraction circuitry 336 may be configured to generate Speech by subtracting Noise (e.g., generated using a mask as described above) from Input. Thus, in some embodiments, the outputs of the mask application and subtraction circuitry 336 may include Speech and Noise (generated as described above).

In some embodiments, the neural network circuitry 308 may be configured to directly output one or more signals themselves, rather than masks. In such embodiments, the mask application and subtraction circuitry 336 may instead just include subtraction circuitry. In some embodiments, application of one or more masks may result in all the signals that need to be generated. In such embodiments, the mask application and subtraction circuitry 336 may instead just include mask application circuitry. In some embodiments, the neural network circuitry 308 may be configured to directly output all the signals that need to be generated. In such embodiments, the mask application and subtraction circuitry 336 may be absent.

Regarding training the neural network implemented by the neural network circuitry 308, in some embodiments training such a neural network may include obtaining a noisy speech audio signal and a speech-isolated version of the audio signal (i.e., with only the speech remaining). In some embodiments, a training mask that, when applied to the noisy speech audio signal, results in the speech-isolated audio signal may be determined. The training input data may be the noisy speech audio signal and the training output data may be the mask. By using multiple sets of such training data in neural network training, the neural network may learn how to output a mask for an audio signal (i.e., “Input”) such that, when the mask is applied to (e.g., multiplied by or added to) the audio signal, the resulting output audio signal is a speech-isolated version of the audio signal (“Speech”). The neural network weights resulting from such training may be those used by the neural network circuitry 308 to implement the neural network during inference. Further description of neural networks for noise reduction may be found in U.S. Pat. No. 11,812,225, titled “Method, Apparatus and System for Neural Network Hearing Aid,” issued Nov. 7, 2023.

The SNS circuitry 340 may be configured to receive Input, generate an estimate of the stationary noise component of Input, and generate one or more SNS outputs 348. In some embodiments, the one or more SNS outputs 348 may include a mask, such that when the mask is applied (e.g., multiplied by or added to) Input, the result is a version of Input with a certain amount of stationary noise removed. In some embodiments, the SNS circuitry 340 may be configured to implement a minimum statistics noise estimation algorithm to generate the estimate of the stationary noise component of Input. In some embodiments, the SNS circuitry 340 may be further configured to implement other algorithms, in addition to or instead of the minimum statistics noise estimation algorithm, to generate the estimate of the stationary noise component of Input and/or to generate the mask. These algorithms may include, among non-limiting examples, spectral subtraction, Wiener filtering, and Ephraim-Malah techniques. Further description of such algorithms may be found in Chung, King. “Challenges and recent developments in hearing aids: Part I. Speech understanding in noise, microphone technologies and noise reduction algorithms.” Trends in Amplification 8.3 (2004): 83-124, which is incorporated by reference herein in its entirety.

The noise gain application circuitry 338 may be configured to apply a gain to the noise estimated by the noise reduction circuitry 306. In some embodiments in which the one or more processed outputs 344 include the neural-network-predicted speech audio signal (“Speech”) and the neural-network-predicted noise audio signal (“Noise), generated as described above based on the one or more neural network outputs 342, the noise gain application circuitry 338 may be configured to generate an output that includes Speech combined with Noise to which has been applied a noise gain. For example, the noise gain application circuitry 338 may be configured to multiply Noise by a gain (e.g., a coefficient less than 1) and summing circuitry 334 may be configured to add the result to Speech. For example, referring to the gain as noise_nn_gain (where “nn” refers to “neural network”), the result of the above operation may be Speech+noise_nn_gain*Noise. It should be appreciated that because Input may be equivalent to Speech+Noise, the result Speech+noise_nn_gain*Noise may be generated by adding other combinations of audio signals, such as Speech and Input or Noise and Input, using appropriate weights.

In some embodiments in which the one or more SNS outputs 348 include a mask, the noise gain application circuitry 338 may be configured to apply (e.g., by multiplication or addition) the mask to the result of mixing the neural-network-predicted noise audio signal and the neural-network-predicted speech audio signal as described above. For example, referring to the mask as mask_sns, the noise gain application circuitry 338 may be configured to generate the result (Speech+noise_nn_gain*Noise)*mask_sns. As described above, the mask_sns may be configured to reduce stationary noise by a certain amount, or in other words, a stationary noise at a certain gain may remain. Thus, the full noise gain implemented by the noise gain application circuitry 338 may be realized by application of noise_nn_gain and mask_sns. In some embodiments (and as will be described further herein), the noise gain application circuitry 38 may be configured to receive a control input 346 and modulate the applied noise gain (e.g., modulate the value of noise_nn_gain and/or the amount of stationary noise reduction implemented by mask_sns) based on the control input 346. The control input 346 may be generated by control circuitry not illustrated in FIG. 3. The output of the noise gain application circuitry 338 may generally be considered an enhanced audio signal and referred to herein as “Enhanced.” Adding noise back to speech may help to increase environmental awareness of a wearer of an ear-worn device, and may also help reduce distortion that may result from use of a neural network.

Following will be a description of WDRC circuitry in more detail. In some embodiments, WDRC circuitry (e.g., the WDRC circuitry 212, the WDRC circuitry 412, the WDRC circuitry 1212, the WDRC circuitry 1112, and/or the WDRC circuitry 512) may be configured to operate on different bands of frequencies separately, with each band of frequencies including one or more bins of frequencies. It should be appreciated that when the below description describes an operation performed on a signal such as Input or Enhanced, this may mean performing the operation independently on different bands of the signal. For example, in some embodiments the WDRC circuitry 412 may be configured to independently determine the speech level in each frequency band with the speech level calculation circuitry 416, independently update the speech level with the level updating circuitry 432, and independently apply WDRC in each frequency band with the WDRC circuitry 422. However, in some embodiments, all frequency bins may be processed together, or in other words, only a single frequency bin may be used. In some embodiments, calculations performed for one frequency bin may be used to process other frequency bins. For example, in some embodiments the WDRC circuitry 412 may be configured to determine the speech level in one frequency band with the speech level calculation circuitry 416, but then update the level of one or more other frequency bins based on that determined speech level.

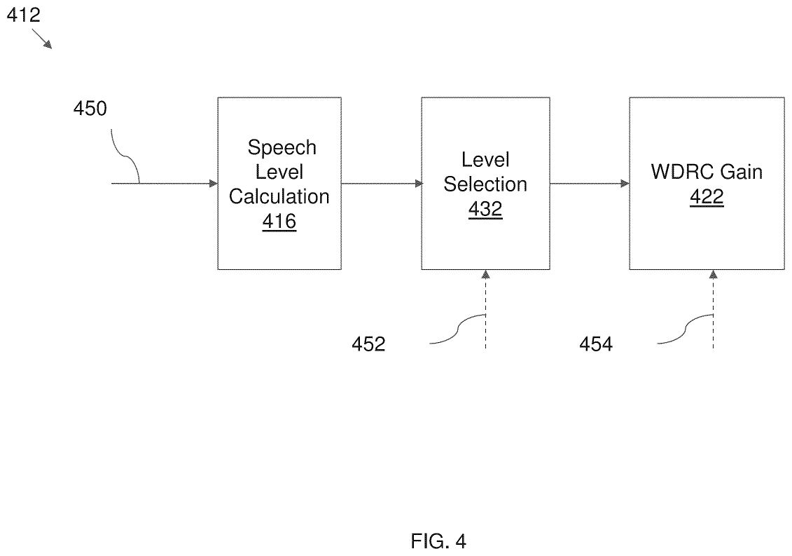

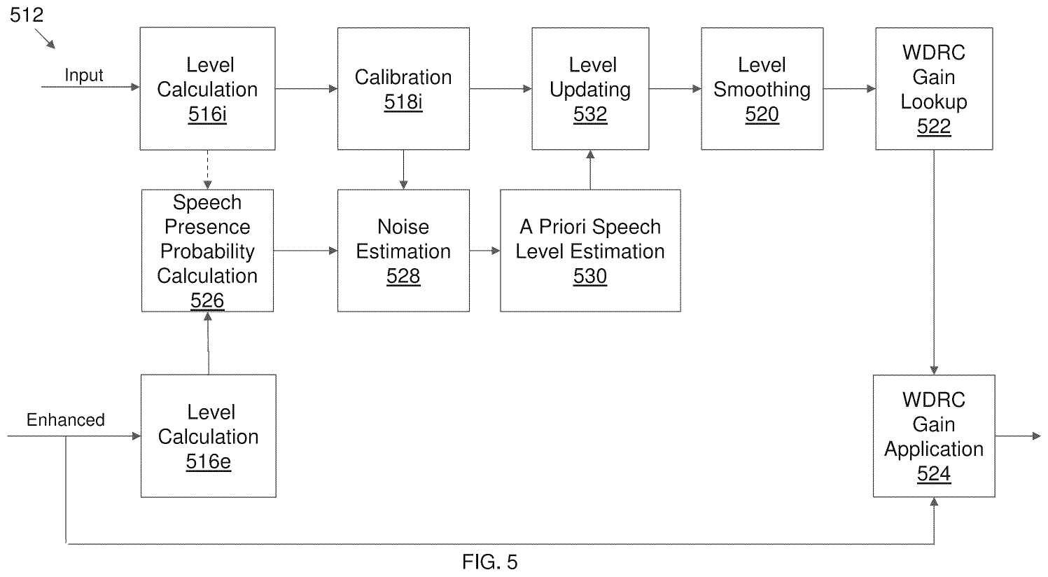

FIG. 4 illustrates WDRC circuitry 412, in accordance with certain embodiments described herein. The WDRC circuitry 412 may be an example of the WDRC circuitry 212. Generally, the WDRC circuitry 412 may be configured to determine a first level that is calculated based, at least in part, on speech in Input; select a level that is the first level if the first level is greater than a threshold level, and a second level (different from the first level), if the first level is not greater than the threshold level; and determine a WDRC gain based on the selected level. Further description of specific implementations of the WDRC circuitry 412 may be found with reference to FIGS. 5-11.

The speech level calculation circuitry 416 may be configured to determine a first level, where the first level is calculated based, at least in part, on speech in Input (e.g., in a particular band of frequencies). However, the speech level calculation circuitry 416 need not necessarily calculate the first level using Input, because the speech component of Input may also be present in or derivable using other signals, such as Speech, Noise, and Enhanced. Thus, the speech level calculation circuitry 416 may be configured to receive one or more signals 450 as input(s), and the one or more signals 450 may include, for example, one or more of Input, Speech, Noise, and Enhanced.

Generally, the speech level calculation circuitry 416 may be configured to calculate the level of a particular signal (e.g., in a particular band of frequencies). In some embodiments, the speech level calculation circuitry 416 may be configured to calculate the power of each bin in a particular band of the signal, sum the powers together, and convert the result to magnitude (e.g., by taking the square root). In some embodiments, each bin may be associated with a weight that determines how much each bin contributes to a given band. In such embodiments, the speech level calculation circuitry 416 may be configured to calculate the power of each bin in the particular band, multiply the power of each bin by that bin's weight, sum the weighted powers together, and convert the result to magnitude (e.g., by taking the square root).

In some embodiments, the one or more signals 450 may include the signal Speech, where Speech may be outputted by the mask application and subtraction circuitry 336 of the noise reduction circuitry 306. In such embodiments, the speech level calculation circuitry 416 may be configured to determine a level of Speech. In some embodiments, the one or more signals 450 may include Enhanced, when Enhanced may be outputted by the noise gain application circuitry 338 of the noise reduction circuitry 306. However, the noise reduction circuitry 306 may be configured not to apply a noise gain when generating Enhanced, such that Enhanced, when received by the WDRC circuitry 412, may not yet include noise, but may instead just include speech. In such embodiments, the speech level calculation circuitry 416 may be configured to determine a level of Enhanced. In some embodiments, the one or more signals 450 may include Enhanced, where Enhanced may be outputted by the noise gain application circuitry 338 of the noise reduction circuitry 306. The noise reduction circuitry 306 may be configured to apply a noise gain when generating Enhanced, such that Enhanced, when received by the WDRC circuitry 1212, includes speech and noise. In such embodiments, the speech level calculation circuitry 416 may be configured to determine a noise component of Enhanced (further description of determining a noise component may be found below), determine a level of Enhanced and a level of the noise component, and subtract the level of the noise component from the level of Enhanced. In some embodiments, the one or more signals 450 may include Input. In such embodiments, the speech level calculation circuitry 416 may be configured to determine a noise component of Input (further description of determining a noise component may be found below), determine a level of Input and a level of the noise component, and subtract the level of the noise component from the level of Input. In some embodiments, the one or more signals 450 may include Input and Noise, where Noise may be outputted by the mask application and subtraction circuitry 336 of the noise reduction circuitry 306. In such embodiments, the speech level calculation circuitry 416 may be configured to determine a level of Input and a level of Noise, and subtract the level of Noise from the level of Input. In some embodiments, the one or more signals 450 may include Input and Enhanced. The noise reduction circuitry 306 may be configured not to apply a noise gain when generating Enhanced, such that Enhanced, when received by the WDRC circuitry 412, may not yet include noise, but may instead just include speech. In such embodiments, the speech level calculation circuitry 416 may be configured to determine a level of Input and a level of Enhanced, and subtract the level of Enhanced from the level of Input.

As described above, the ear-worn device may include noise reduction circuitry (e.g., the noise reduction circuitry 306) including neural network circuitry (e.g., the neural network circuitry 308) configured to generate one or more neural network outputs (e.g., the neural network outputs 342) based on Input. The speech level calculation circuitry 416 may be configured to determine the first level in the input audio signal based on the one or more neural network outputs. In some embodiments, the one or more neural network outputs may be used (e.g., by the mask application and subtraction circuitry 336) to determine Speech and/or Noise. For example, the one or more neural network outputs may include a mask that, when applied to Input, results in Speech or Noise, which may be used to determine the first level as described above.

In some embodiments, the speech level calculation circuitry 416 may be configured to use a neural network to determine (e.g., in a particular band of frequencies) the noise component of Input (i.e., Noise), as described above with reference to FIG. 3. In some embodiments, the speech level calculation circuitry 416 may be configured to determine a stationary noise component of Input or Enhanced. Further description of stationary noise suppression circuitry may be found above with reference to the SNS circuitry 340. In some embodiments, the speech level calculation circuitry 416 may be configured to use speech presence prediction (SPP) to determine a noise component of Input or Enhanced. The speech level calculation circuitry 416 circuitry may be configured to calculate SPP, namely a probability that Input or Enhanced (e.g., in a particular band of frequencies) contains speech and converting the difference to a probability (e.g., using a sigma function). The speech level calculation circuitry 416 circuitry may be further configured to estimate a noise level of Input or Enhanced (e.g., in a particular band of frequencies) based on the probability that Input or Enhanced (e.g., in that particular band of frequencies) contains speech (i.e., based on the SPP calculated as described above). In some embodiments, the speech level calculation circuitry 416 circuitry may be configured to use a recursive algorithm to calculate the estimate of the level of noise. In some embodiments, the recursive algorithm to calculate the estimate of the level of noise (noise_estimate) may be noise_estimate=noise_estimate+smooth_coef*(1−SPP)*(band_level-noise_estimate), where band_level is the level of Input or Enhanced (i.e., within a particular band), and smooth_coef is a coefficient. The time-constant corresponding to the value of smooth_coef may be, for example, around equal to or approximately equal to 70 ms. When there is no speech, the noise estimate may just be a smoothed version of the level of Input or Enhanced. When there is speech, the noise estimate may be kept constant.

In some embodiments, the speech level calculation circuitry 416 may be further configured to calibrate (e.g., in a particular band of frequencies) the first level so that the level can be interpreted as dB SPL. In some embodiments, the speech level calculation circuitry 416 may be configured to calibrate for the spectral shape of speech and the differences in bandwidth between the different bands. Speech may have more energy at low frequencies than at high frequencies, and bands at lower frequencies may be narrower than bands at higher frequencies.

The level selection circuitry 432 may be configured to select (e.g., for a particular band of frequencies) a level that is the first level (i.e., the level calculated by the speech level calculation circuitry 416 based, at least in part, on speech in Input) if the first level is greater than a threshold level, and select a second level (different from the first level) if the first level is not greater than the threshold level. (In some embodiments the first level may be selected if it is equal to the threshold level, and in some embodiments the second level may be selected if the first level is equal to the threshold level. In either case, it may still be said that the first level is selected if it is greater than the threshold level, and the second level is selected if the first level is not greater than the threshold level.) In some embodiments, the threshold level and the second level may be different. In such embodiments, the second level may be greater than the threshold level. In some embodiments, the threshold level and the second level may be the same. In some embodiments, the threshold level may indicate whether speech is present in the input audio signal. In such embodiments, the level selection circuitry 432 may be configured to select the first level when there is speech present (i.e., the first level is greater than the threshold level for when speech is present) and select the second level when speech is not present. In such embodiments, the threshold level and the second level may be different. In some embodiments, determining whether the first level is greater than a threshold level may be performed by using SPP and comparing the SPP to a threshold. In some embodiments, the level selection circuitry 432 may be configured to select whichever of the first level and the second level is greater. In such embodiments, the threshold level and the second level may be the same.

In some embodiments, the threshold level may depend on the noise level, and thus the level selection circuitry 432 may be configured to perform noise estimation (e.g., as described above). For example, the threshold level may be the a priori speech level (described further below). In some embodiments, the threshold level may be equal to or approximately equal to 40 dB SPL. In some embodiments, the threshold level may be equal to or approximately equal to 45 dB SPL. In some embodiments, the threshold level may be equal to or approximately equal to 50 dB SPL. In some embodiments, the threshold level may be equal to or approximately equal to 55 dB SPL. In some embodiments, the threshold level may be equal to or approximately equal to 60 dB SPL. In some embodiments, the threshold level may be between 40 and 60 dB SPL. In some embodiments, the threshold level may between 45 and 55 db SPL

In some embodiments, the level selection circuitry 432 may be configured to receive one or more inputs 452 that it may use to determine the other level. In some embodiments, the second level may be based, at least in part, on a noise level of Input. In such embodiments, the second level may generally be related to the level of speech that there would be if speech were present. This may also be referred to as an a priori speech level. The noise level may be determined by the speech level calculation circuitry 416 or by the level selection circuitry 432. Further description of determining noise level may be found above. According to the Lombard effect, people tend to speak louder in noisier environments. The actual speech output level given a particular background noise level in a particular band may be estimated as

$${L}_{pff 1 , n} = {L}_{pff 1 , q} + \frac{asym}{\{ 1 + exp [ ( xmid - {L}_{n} ) / scale ] \}} ,$$

where L_{pffl,n} is the speech output level at which a speaker would speak in the absence of background noise; Lₙ is the background noise level; asym, xmid, and scale are Lombard-effect parameters; and L_{pffl,n} is the speech output level at the particular background noise level. With regards to the Lombard-effect parameters, the model assumes that speech output levels vary between a minimum of L_{pffl,q} and a maximum of L_{pffl,q}+asym. The model further assumes that the speech output levels vary such that, when the background noise level is xmid, the slope of the speech output level vs. background noise level is asym/(4scale) dB/dB. The level selection circuitry 432 may be configured to determine a speech level (e.g., in a particular frequency band) based on the noise level using the formula described above. In some embodiments, the one or more inputs 452 may be used by the level selection circuitry 432 to calculate the noise level.

In some embodiments, the second level may be based, at least in part, on a previous level (e.g., a most recent level) of speech in Input (i.e., when speech was present). In such embodiments, the level selection circuitry 432 may be configured to store a current speech level in memory as the previous (or most recent) speech level. The level selection circuitry 432 may be configured to overwrite a previously-stored speech level when storing this speech level. In some embodiments, the one or more inputs 452 may be the previous speech level received from memory external to the level selection circuitry 432. In some embodiments, the memory may be internal to the level selection circuitry 432.

In some embodiments, the second level is based, at least in part, on a predetermined constant level. In some embodiments, the one or more inputs 452 may be the predetermined constant level received from memory external to the level selection circuitry 432. In some embodiments, the memory may be internal to the level selection circuitry 432. In some embodiments, the constant may be equal to or approximately equal to 50 dB SPL. In some embodiments, the threshold level may be equal to or approximately equal to 55 dB SPL. In some embodiments, the threshold level may be equal to or approximately equal to 60 dB SPL. In some embodiments, the threshold level may be equal to or approximately equal to 65 dB SPL. In some embodiments, the threshold level may be equal to or approximately equal to 70 dB SPL. In some embodiments, the threshold level may be between 50 and 70 dB SPL. In some embodiments, the threshold level may between 55 and 65 dB SPL

In some embodiments, the second speech level may be based on a combination of two or more levels (e.g., some combination of two or more of a speech level determined based on the noise level, a previous speech level, and a predetermined constant level).

The level selection circuitry 432 may be further configured to smooth the selected level (e.g., in a particular band of frequencies). In some embodiments, the level selection circuitry 432 may be configured to perform asymmetric smoothing using different attack and release times. In more detail, the level selection circuitry 432 may be configured to continuously calculate a smoothed level (smooth_level) and compare the smoothed level to the instantaneous level (inst_level). If smooth_level is less than inst_level, then the level smoothing circuitry 520 may be configured to update smooth_level to be smooth_level+attack_coef*(inst_level-smooth_level). Otherwise, the level smoothing circuitry 520 may be configured to update smooth_level to be smooth_level+release_coef*(inst_level-smooth_level). The coefficients attack_coef and release_coef may control how fast smooth_level responds to rising or falling levels, respectively. As example values, the time-constant corresponding to the value of attack_coef may be 32 ms and the time-constant corresponding to the value of release_coef may be 128 ms. Depending on the goal of the compression, the attack and release times may be fast or slow. Release times are generally longer than attack times to limit distortion of the sound. Release times shorter than 20 ms may be considered fast. Slow attack and release times are typically better for sound quality while fast attack and release time might maximize speech intelligibility. Some embodiments may have adaptive attack and release times where the attack and release times depend on the content of the audio signal.

The WDRC gain circuitry 422 may be configured to determine a gain based on the level received from the level selection circuitry 432, as well as the particular band of frequencies. In some embodiments, the WDRC gain circuitry 422 may be configured to use a lookup table. The lookup table may associate different combinations of frequencies and levels with different gains, and the WDRC gain circuitry 422 may be configured to look up the level in a particular frequency band (as received from the level selection circuitry 432) and the particular frequency band in the lookup table and output the gain associated with that level and frequency band in the lookup table. In some embodiments, the WDRC gain circuitry 422 may be configured to interpolate the current level into a line between two levels in the lookup table and thereby determine a gain for the current level, even if the current level is not explicitly in the lookup table. In some embodiments, the WDRC gain circuitry 422 may be configured to use a formula. For example, a WDRC curve for a particular frequency band may be defined by a formula (such as a line) relating level to gain, such as a line. The WDRC gain circuitry 422 may be configured to input a level into the formula and determine a gain based on the output of the formula.

The WDRC gain circuitry 422 may be further configured to apply the gain to a signal 454 (e.g., in a particular band of frequencies). In some embodiments, the signal 454 may be the same as one of the one or more signals 450. For example, the signal 450 and the signal 454 may both be Input. As another example, the signal 450 and the signal 454 may both be Enhanced. In some embodiments, the signal 454 may be different from the one or more signals 450. For example, the signal 450 may be Input and the signal 454 may be Enhanced. The WDRC gain circuitry 422 may be configured to apply the gain (determined as described above) to the particular frequency band of the signal 454, thereby generating the output of the WDRC circuitry 412. When applying the WDRC gain to Enhanced, in some embodiments Enhanced may already have noise added to it (e.g., by the noise gain application circuitry 338), while in some embodiments Enhanced may not have noise added to it. (Whether noise is added or not may be controlled by the control input 346.) In the latter case, the WDRC gain circuitry 422 may be further configured to add noise back to Enhanced (e.g., the noise gain application circuitry 338 may be implemented in the WDRC gain circuitry 422).

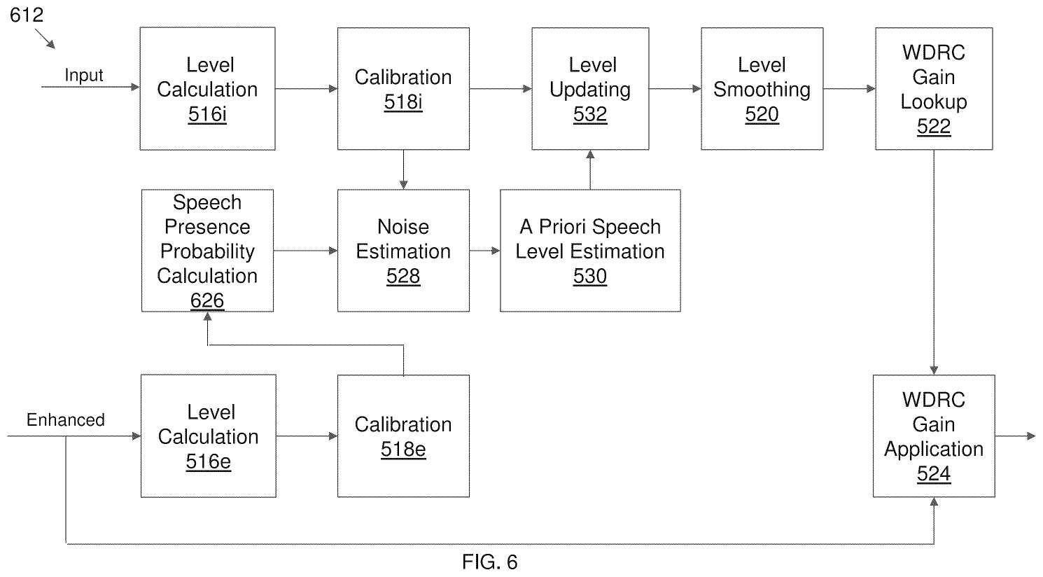

FIG. 5 illustrates WDRC circuitry 512, in accordance with certain embodiments described herein. The WDRC circuitry 512 may be an example of the WDRC circuitry 212, and may furthermore be an example of the WDRC circuitry 412. (It should be appreciated that in FIG. 5, certain functions described with reference to one block of the WDRC circuitry 412 may be performed by multiple blocks of the WDRC circuitry 512, and certain functions described with reference to one block of the WDRC circuitry 512 may be performed by multiple blocks of the WDRC circuitry 412. The same may apply to WDRC circuitry illustrated in FIGS. 6-11.) When using the WDRC circuitry 512, the noise reduction circuitry (e.g., the noise reduction circuitry 306) downstream of the WDRC circuitry 512 may be set (e.g., using the control input 346) to apply a noise gain when generating Enhanced, such that Enhanced already includes speech plus noise when received by the WDRC circuitry 512. Further description of certain circuitry in the WDRC circuitry 512 may be found above with reference to FIGS. 3 and 4.

The level calculation circuitry 516i may be configured to calculate the level of Input (e.g., in a particular band of frequencies). The level calculation circuitry 516e may be configured to calculate the level of Enhanced. In some embodiments, the level calculation circuitry 516 may be configured to calculate the power of each bin in a particular band, sum the powers together, and convert the result to magnitude (e.g., by taking the square root). In some embodiments, each bin may be associated with a weight that determines how much each bin contributes to a given band. In such embodiments, the level calculation circuitry 516 may be configured to calculate the power of each bin in the particular band, multiply the power of each bin by that bin's weight, sum the weighted powers together, and convert the result to magnitude (e.g., by taking the square root).

The calibration circuitry 518i may be configured to calibrate the level of Input received from the level calculation circuitry 516i (e.g., in a particular band of frequencies) so that the level can be interpreted as dB SPL. In some embodiments, the calibration circuitry 518i may be configured to calibrate for the spectral shape of speech and the differences in bandwidth between the different bands. Speech may have more energy at low frequencies than at high frequencies, and bands at lower frequencies may be narrower than bands at higher frequencies.

The speech presence probability (SPP) calculation circuitry 526 may be configured to calculate SPP, namely a probability that Input (in a particular band of frequencies) contains speech. In some embodiments, the SPP calculation circuitry 526 may be configured to calculate SPP by determining the difference between Input and Enhanced and converting the difference to a probability (e.g., using a sigma function).

The noise estimation circuitry 528 may be configured to estimate a noise level of Input (e.g., in a particular band of frequencies) based on the probability that Input (e.g., in that particular band of frequencies) contains speech (i.e., based on the SPP as calculated by the SPP calculation circuitry 526). In some embodiments, the noise estimation circuitry 528 may be configured to use a recursive algorithm to calculate the estimate of the level of noise. In some embodiments, the recursive algorithm to calculate the estimate of the level of noise (noise_estimate) may be noise_estimate=noise_estimate+smooth_coef*(1−SPP)*(band_level-noise_estimate), where band_level is the level of Input (i.e., within a particular band), and smooth_coef is a coefficient. The time-constant of smooth_coef may be, for example, around equal to or approximately equal to 70 ms. When there is no speech, the noise estimate may just be a smoothed version of the level of Input. When there is speech, the noise estimate may be kept constant.

The a priori speech level estimation circuitry 530 may be configured to determine an a priori speech level (for a particular band of frequencies) based on the noise level of Input calculated by the noise estimation circuitry 528. According to the Lombard effect, people tend to speak louder in noisier environments. The actual speech output level given a particular background noise level in a particular band may be estimated as

$${L}_{pff 1 , n} = {L}_{pff 1 , q} + \frac{asym}{\{ 1 + exp [ ( xmid - {L}_{n} ) / scale ] \}} ,$$

where L_{pffl,n} is the speech output level at which a speaker would speak in the absence of background noise; Lₙ is the background noise level; asym, xmid, and scale are Lombard-effect parameters; and L_{pffl,n} is the speech output level at the particular background noise level. With regards to the Lombard-effect parameters, the model assumes that speech output levels vary between a minimum of L_{pffl,q} and a maximum of L_{pffl,q}+asym. The model further assumes that the speech output levels vary such that, when the background noise level is xmid, the slope of the speech output level vs. background noise level is asym/(4scale) dB/dB. The a priori speech level estimation circuitry 530 may be configured to determine a speech level (e.g., in a particular frequency band) based on the noise level using the formula described above.

The level updating circuitry 532 may be configured to estimate the speech level of Input (e.g., in a particular band of frequencies). In some embodiments, the level updating circuitry 532 may be configured to estimate the speech level of Input by subtracting the noise level (determined by the noise estimation circuitry 528) from the level of Input (as outputted by the calibration circuitry 518i). In some embodiments, the level updating circuitry 532 may be configured to select either the speech level of Input or the a priori speech level (as received from the a priori speech level estimation circuitry 530). The selected speech level may be considered the updated speech level of Input and outputted to the level smoothing circuitry 520. Thus, the level of Input may be at least the a priori speech level as determined by the a priori speech level estimation circuitry 530. In some embodiments, the level updating circuitry 532 may be configured to select the current speech level if it is higher than a threshold, and otherwise select the a priori speech level. The selected speech level may be considered the updated speech level of Input and outputted to the level smoothing circuitry 520. In some embodiments, the threshold level may be the same as the a priori speech level (generated by the a priori speech level circuitry 530), or generally, may depend on the noise estimate (generated by the noise estimation circuitry 528).

The level smoothing circuitry 520 may be configured to smooth the level of Input received from the level updating circuitry 532 (e.g., in a particular band of frequencies). In some embodiments, the level smoothing circuitry 520 may be configured to perform asymmetric smoothing using different attack and release times. In more detail, the level smoothing circuitry 520 may be configured to continuously calculate a smoothed level (smooth_level) and compare the smoothed level to the instantaneous level (inst_level). If smooth_level is less than inst_level, then the level smoothing circuitry 520 may be configured to update smooth_level to be smooth_level+attack_coef*(inst_level-smooth_level). Otherwise, the level smoothing circuitry 520 may be configured to update smooth_level to be smooth_level+release_coef*(inst_level-smooth_level). The coefficients attack_coef and release_coef may control how fast smooth_level responds to rising or falling levels, respectively. As example values, attack_coef may have a time-constant of 32 ms and release_coef may have a time-constant of 128 ms. Because this example attack time-constant is faster than this example release time-constant, smoothing using such values may be considered to use fast attack and slow release times.

The WDRC gain lookup circuitry 522 may be configured to determine a WDRC gain (e.g., for a particular band of frequencies) based on the level of Input received from the level smoothing circuitry 520. In some embodiments, the WDRC gain lookup circuitry 522 may be configured to use a lookup table. The lookup table may associate different combinations of frequencies and levels with different gains, and the WDRC gain lookup circuitry 522 may be configured to look up the level of Input in a particular frequency band (as received from the level smoothing circuitry 520) and the particular frequency band in the lookup table and output the gain associated with that level and frequency band in the lookup table. In some embodiments, the WDRC gain lookup circuitry 522 may be configured to interpolate the current level into a line between two levels in the lookup table and thereby determine a gain for the current level, even if the current level is not explicitly in the lookup table. In some embodiments, the WDRC gain lookup circuitry 522 may be configured to use a formula. For example, a WDRC curve for a particular frequency band may be defined by a formula (such as a line) relating level to gain, such as a line. The WDRC gain lookup circuitry 522 may be configured to input a level into the formula and determine a gain based on the output of the formula.

The WDRC gain application circuitry 524 may be configured to apply the gain from the WDRC gain lookup circuitry 522 to Enhanced (e.g., for a particular band of frequencies). In particular, the WDRC gain application circuitry 524 may be configured to apply the gain to the particular frequency band of Enhanced, thereby generating the output of the WDRC circuitry 5. Thus, the output of the WDRC gain application circuitry 524 may be wdrc_gain*Enhanced, where wdrc_gain is the WDRC gain determined by the WDRC gain application circuitry 524.

FIG. 6 illustrates WDRC circuitry 612, in accordance with certain embodiments described herein. The WDRC circuitry 612 may be an example of the WDRC circuitry 212, and may furthermore be an example of the WDRC circuitry 412. The WDRC circuitry 612 is the same as the WDRC circuitry 512, except that the SPP calculation circuitry 626 may be configured to calculate SPP using Enhanced but not Input. For example, the SPP calculation circuitry 526 may be configured to calculate SPP by comparing Enhanced to a threshold and converting the difference to a probability (e.g., using a sigma function). Additionally, when using just Enhanced and not both Enhanced and Input to calculate SPP, it may be necessary to calibrate Enhanced first. Accordingly, calibration circuitry 518e is included before the SPP calculation circuitry 526.

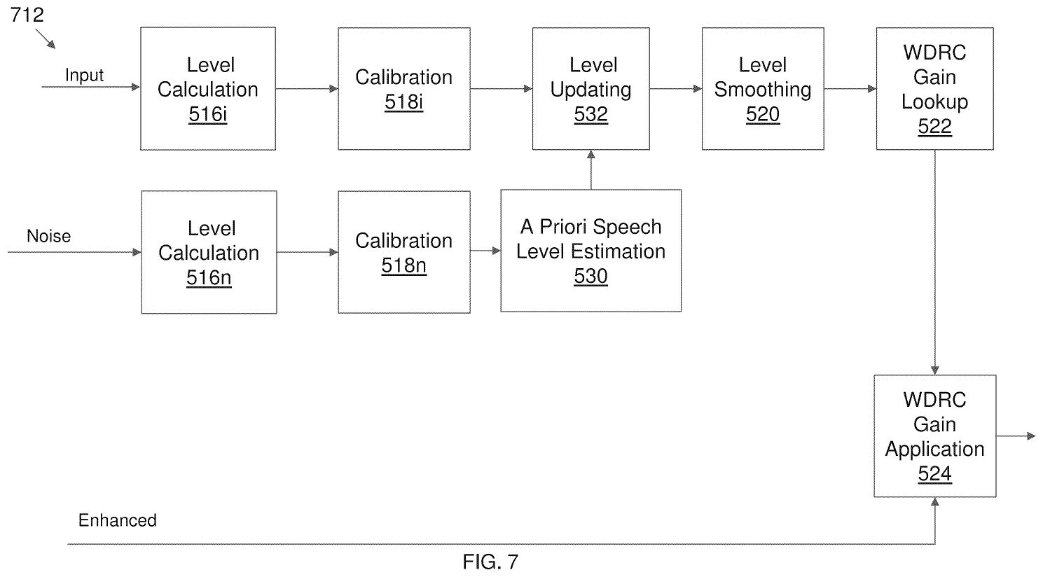

FIG. 7 illustrates WDRC circuitry 712, in accordance with certain embodiments described herein. The WDRC circuitry 712 may be an example of the WDRC circuitry 212, and may furthermore be an example of the WDRC circuitry 412. The WDRC circuitry 712 is the same as the WDRC circuitry 612, except that the noise level may be calculated using Noise, instead of the SPP calculation circuitry 526 and the noise estimation circuitry 528. In particular, level calculation circuitry 516n may be configured to calculate the level of Noise and the calibration circuitry 518n may be configured to calibrate the level of Noise.

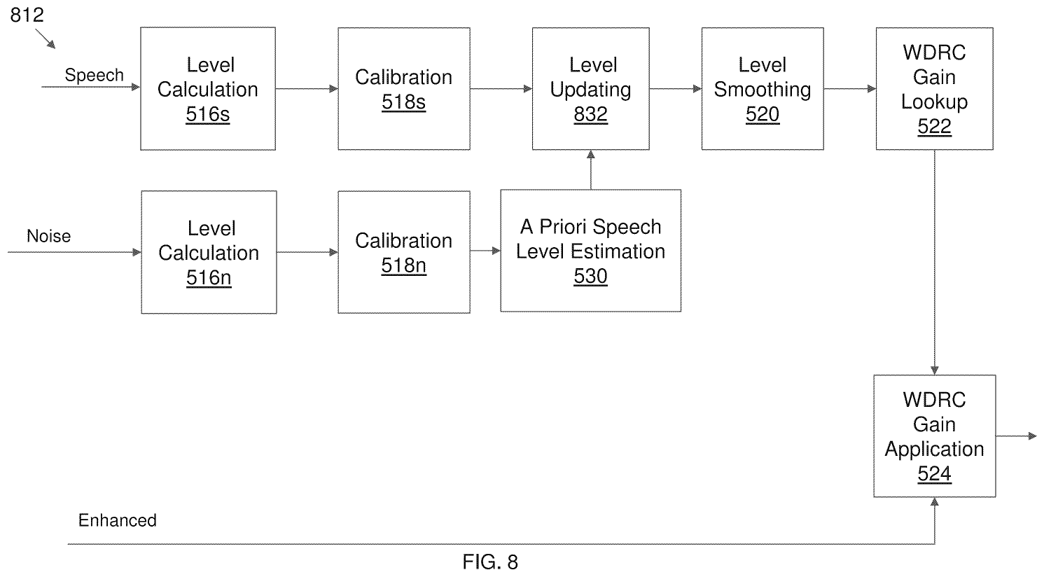

FIG. 8 illustrates WDRC circuitry 812, in accordance with certain embodiments described herein. The WDRC circuitry 812 may be an example of the WDRC circuitry 212, and may furthermore be an example of the WDRC circuitry 412. The WDRC circuitry 812 is the same as the WDRC circuitry 712, except that the level calculation circuitry 516s is configured to calculate the level of Speech, and the calibration circuitry 518s is configured to calibrate the level of Speech. The level updating circuitry 832 may then not be configured to calculate the speech level.

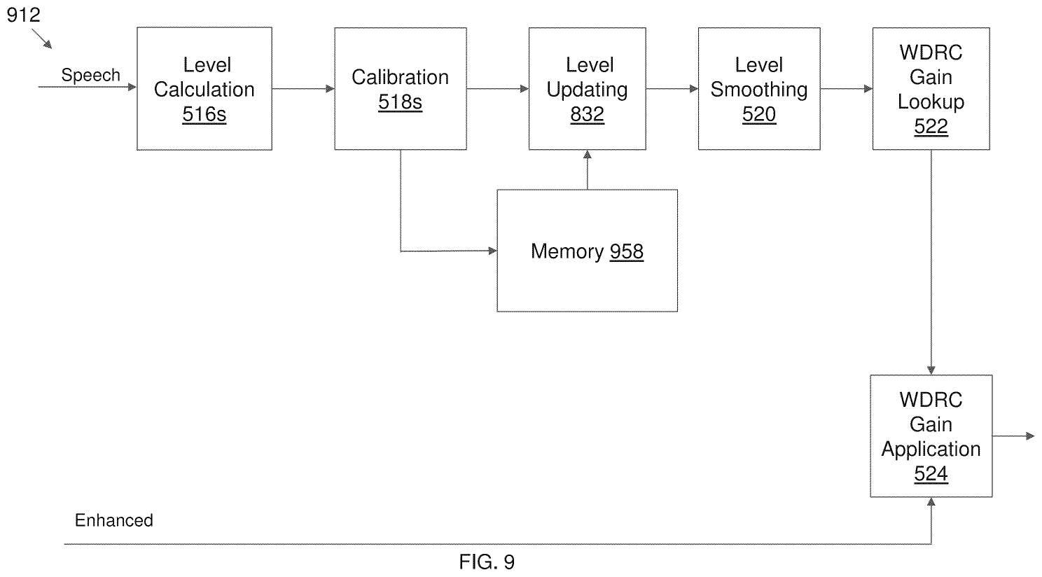

FIG. 9 illustrates WDRC circuitry 912, in accordance with certain embodiments described herein. The WDRC circuitry 912 may be an example of the WDRC circuitry 212, and may furthermore be an example of the WDRC circuitry 412. The WDRC circuitry 912 is the same as the WDRC circuitry 712, except that the WDRC circuitry 912 does not perform noise estimation or a priori speech estimation. Instead, the WDRC circuitry 912 includes memory 958. The memory 958 may be configured to store a speech level from the calibration circuitry 518s. In some embodiments, the memory 958 may only be configured to store the speech level if the speech level is above a threshold (e.g., a threshold indicating that speech is actually present). Control circuitry (not illustrated) may control whether the memory 958 stores the speech level or not. In some embodiments, the previous speech level stored in the memory 958 may be the most recent speech level. In some embodiments, the memory 958 may be configured to overwrite a previously-stored speech level with the current speech level. At a later time, the level updating circuitry 832 may be configured to retrieve that previous speech level and select either the new current speech level or the previous speech level. For example, in some embodiments, the level updating circuitry 832 may be configured to select the maximum of the current speech level and the previous speech level. In some embodiments, the level updating circuitry 832 may be configured to select the current speech level if it is higher than a threshold, and otherwise select the previous speech level from memory. The selected speech level may be considered the updated speech level and outputted to the level smoothing circuitry 520.

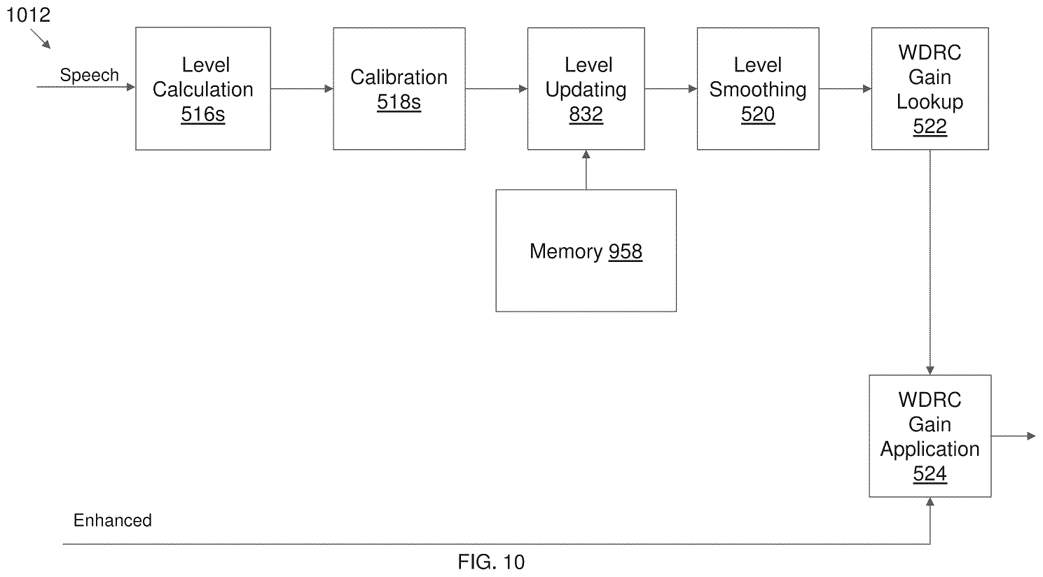

FIG. 10 illustrates WDRC circuitry 1012, in accordance with certain embodiments described herein. The WDRC circuitry 1012 may be an example of the WDRC circuitry 212, and may furthermore be an example of the WDRC circuitry 412. The WDRC circuitry 1012 is the same as the WDRC circuitry 912, except that the memory 958 may not be configured to store a speech level from the calibration circuitry 518s. The memory 958 may be configured to store a predetermined constant level. The level updating circuitry 832 may be configured to retrieve that predetermined constant level and select either the current speech level or the predetermined constant level. For example, in some embodiments, the level updating circuitry 832 may be configured to select the maximum of the current speech level and the predetermined constant level. In some embodiments, the level updating circuitry 832 may be configured to select the current speech level if it is higher than a threshold, and otherwise select the predetermined constant level. The selected level may be considered the updated speech level and outputted to the level smoothing circuitry 520.

It should be appreciated that certain combinations of the WDRC circuitries 512-1012 may be used as well. For example, the memory 958 and level updating circuitry 832 of the WDRC circuitry 912 or 1012 may be used in the WDRC circuitry 512, 612, or 712. As another example, the memory 958 and the a priori speech estimation circuitry 530 may both be used.

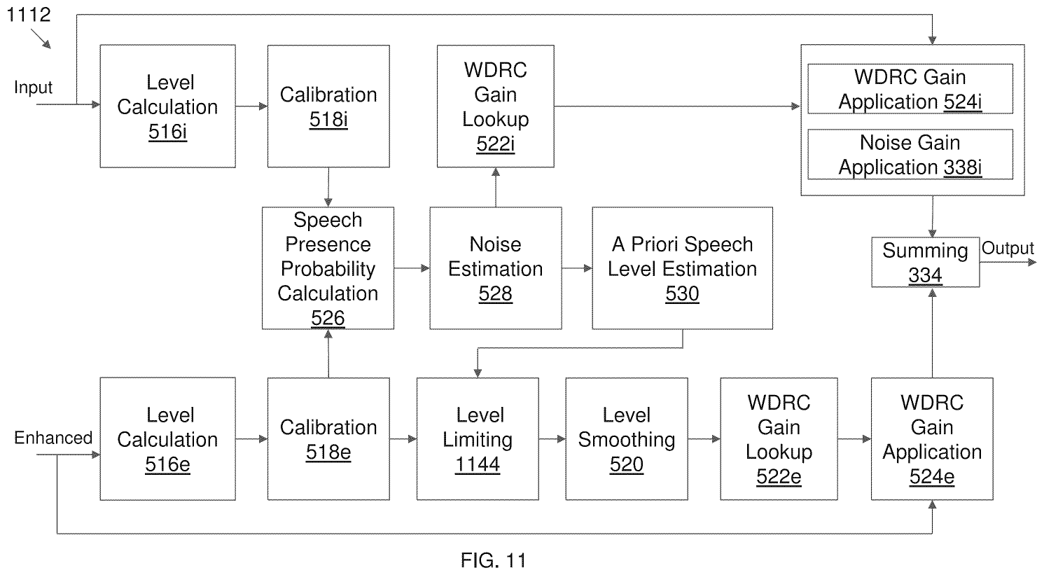

FIG. 11 illustrates WDRC circuitry 1112, in accordance with certain embodiments described herein. The WDRC circuitry 1112 may be an example of the WDRC circuitry 212, and may furthermore be an example of the WDRC circuitry 412. When using the WDRC circuitry 1112, the noise reduction circuitry (e.g., the noise reduction circuitry 306) downstream of the WDRC circuitry 1112 may be set (e.g., using the control input 346) not to apply a noise gain when generating Enhanced, such that Enhanced, when received by the WDRC circuitry 1112, may not yet include noise, but may instead just include speech. Thus, in some embodiments of the WDRC 1112, Enhanced and Speech may be equivalent. As will be described below, the WDRC circuitry 1112 may be configured to add noise to Enhanced with a noise gain. Further description of certain circuitry in the WDRC circuitry 1112 may be found above with reference to FIGS. 3, 4, and 5.

The level calculation circuitry 516i may be configured to calculate the level of Input. The level calculation circuitry 516e may be configured to calculate the level of Enhanced The calibration circuitry 518i may be configured to calibrate the level of Input received from the level calculation circuitry 516i so that the level can be interpreted as dB SPL. The calibration circuitry 518e may be configured to calibrate the level of Enhanced received from the level calculation circuitry 516e so that the level can be interpreted as dB SPL.

The speech presence probability (SPP) calculation circuitry 526 may be configured to calculate SPP, namely a probability that Input (e.g., in a particular band of frequencies) contains speech. In some embodiments, the SPP calculation circuitry 526 may be configured to calculate SPP by determining the difference between Input and Enhanced and converting the difference to a probability (e.g., using a sigma function).

The noise estimation circuitry 528 may be configured to estimate a noise level of Input (e.g., in a particular band of frequencies) based on the probability that Input (e.g., in that particular band of frequencies) contains speech (i.e., based on the SPP as calculated by the SPP calculation circuitry 526).

The a priori speech level estimation circuitry 530 may be configured to determine an a priori speech level (e.g., for a particular band of frequencies) based on the noise level of Input calculated by the noise estimation circuitry 528 for that band.

The level limiting circuitry 1144 may be configured to limit the level of Enhanced to the maximum of the level of Enhanced (as received from the calibration circuitry 518e) and the a priori speech level based on the noise level of Input (as received from the a priori speech level estimation circuitry 530). Thus, the level may be at least the a priori speech level as determined by the a priori speech level estimation circuitry 530. The level smoothing circuitry 520 may be configured to smooth the level of Enhanced received from the level limiting circuitry 1144.

The WDRC gain lookup circuitry 522e may be configured to determine a WDRC gain based on the level of Enhanced received from the level smoothing circuitry 520. As described above, the level of Enhanced may have been limited (by the level limiting circuitry 1144) to the maximum of the level of Enhanced and the a priori speech level. The WDRC gain application circuitry 524e may be configured to apply the gain from the WDRC gain lookup circuitry 522e to Enhanced. Thus, the output of the WDRC gain application circuitry 524e may be wdrc_gain_enhanced*Enhanced, where wdrc_gain_enhanced is the WDRC gain determined by the WDRC gain application circuitry 524e. The WDRC gain lookup circuitry 522i may be configured to determine a gain based on the noise level from the noise estimation circuitry 528. The WDRC gain application circuitry 524i may be configured to apply the gain from the WDRC gain lookup circuitry 522i to Input. The noise gain application circuitry 338i may be configured to apply a noise gain to Input. As described above with reference to the noise gain application circuitry 338, a noise gain may be realized by application of a coefficient noise_nn_gain and a mask_sns. Thus, the output of the WDRC gain application circuitry 524i and the noise gain application circuitry 338i may be wdrc_gain_input*noise_nn_gain*mask_sns*Input. It should be appreciated that the WDRC gain application circuitry 524i and the noise gain application circuitry 338i may be configured to apply their gains one after another (in any order) or at the same time. The summing circuitry 334 may be configured to sum the output of the WDRC gain application circuitry 524e and the combined output of the WDRC gain application circuitry 1124i and noise gain application circuitry 338i, thereby generating the output of the WDRC circuitry 1112, which may be equivalent to wdrc_gain_enhanced*Enhanced+wdrc_gain_input*noise_nn_gain*mask_sns*Input. It should be appreciated that because Input may be equivalent to Speech+Noise, and because in the example of FIG. 5 Enhanced may just include Speech, then the above expression for the output signal may represent adding noise back to speech. While adding noise back to speech may be accomplished upstream of the WDRC circuitry 512 (for example), in the WDRC circuitry 1112 noise may be added back to speech by the WDRC circuitry 1112 itself.

It should be appreciated that certain combinations of the WDRC circuitries 1112 and 612-1012 may be used as well. For example, the SPP calculation circuitry 626 of the WDRC circuitry 612 may be used in the WDRC circuitry 1112. As another example, the level calculation circuitry 616n and the calibration circuitry 518n of the WDRC circuitry 712 may be used in the WDRC circuitry 1112. As another example, the memory 958 and level updating circuitry 832 of the WDRC circuitry 912 or 1012 may be used in the WDRC circuitry 1112. As another example, the memory 958 and the a priori speech estimation circuitry 530 may both be used.

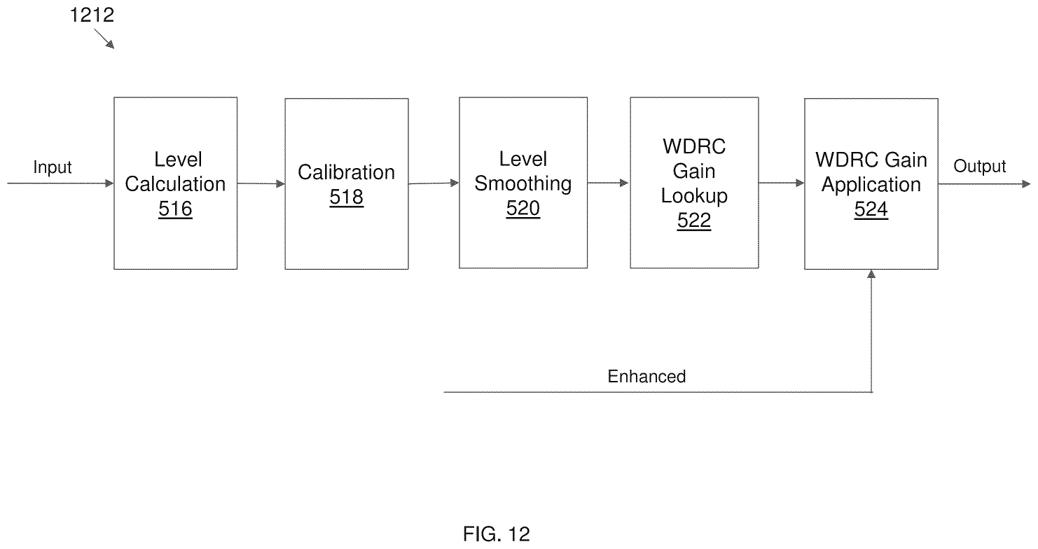

FIG. 12 illustrates WDRC circuitry 1212, in accordance with certain embodiments described herein. The WDRC circuitry 1212 may be an example of the WDRC circuitry 212. Generally, the WDRC circuitry 1212 may be configured to determine a WDRC gain based on a level of an input audio signal (i.e., Input) and apply the WDRC gain to a noise-reduced version of the input audio signal (i.e., Enhanced), thereby generating the output audio signal from the WDRC circuitry 1212. When using the WDRC circuitry 1212, the noise reduction circuitry (e.g., the noise reduction circuitry 306) downstream of the WDRC circuitry 1212 may be set (e.g., using the control input 346) to apply a noise gain when generating Enhanced, such that Enhanced already includes speech plus noise when received by the WDRC circuitry 1212.

The level calculation circuitry 516 may be configured to calculate the level of Input. In some embodiments, the level calculation circuitry 516 may be configured to calculate the power of each bin in a particular band, sum the powers together, and convert the result to magnitude (e.g., by taking the square root). In some embodiments, each bin may be associated with a weight that determines how much each bin contributes to a given band. In such embodiments, the level calculation circuitry 516 may be configured to calculate the power of each bin in the particular band, multiply the power of each bin by that bin's weight, sum the weighted powers together, and convert the result to magnitude (e.g., by taking the square root).

The calibration circuitry 518 may be configured to calibrate the level of Input received from the level calculation circuitry 516 so that the level can be interpreted as dB SPL. In some embodiments, the calibration circuitry 518 may be configured to calibrate for the spectral shape of speech and the differences in bandwidth between the different bands. Speech may have more energy at low frequencies than at high frequencies, and bands at lower frequencies may be narrower than bands at higher frequencies.

The level smoothing circuitry 520 may be configured to smooth the level of Input received from the calibration circuitry 518. In some embodiments, the level smoothing circuitry 520 may be configured to perform asymmetric smoothing using different attack and release times. In more detail, the level smoothing circuitry 520 may be configured to continuously calculate a smoothed level (smooth_level) and compare the smoothed level to the instantaneous level (inst_level). If smooth_level is less than inst_level, then the level smoothing circuitry 520 may be configured to update smooth_level to be smooth_level+attack_coef*(inst_level-smooth_level). Otherwise, the level smoothing circuitry 520 may be configured to update smooth_level to be smooth_level+release_coef*(inst_level-smooth_level). The coefficients attack_coef and release_coef may control how fast smooth_level responds to rising or falling levels, respectively. As example values, attack_coef may have a time-constant of 32 ms and release_coef may have a time-constant of 128 ms. Because this example attack time-constant is faster than this example release time-constant, smoothing using such values may be considered to use fast attack and slow release times.

The WDRC gain lookup circuitry 522 may be configured to determine a gain based on the level of Input received from the level smoothing circuitry 520 as well as the particular band of frequencies. In some embodiments, the WDRC gain lookup circuitry 522 may be configured to use a lookup table. The lookup table may associate different combinations of frequencies and levels with different gains, and the WDRC gain lookup circuitry 522 may be configured to look up the level of Input in a particular frequency band (as received from the level smoothing circuitry 520) and the particular frequency band in the lookup table and output the gain associated with that level and frequency band in the lookup table. In some embodiments, the WDRC gain lookup circuitry 522 may be configured to interpolate the current level into a line between two levels in the lookup table and thereby determine a gain for the current level, even if the current level is not explicitly in the lookup table.

The WDRC gain application circuitry 524 may be configured to apply the gain from the WDRC gain lookup circuitry 522 to Enhanced. In particular, the WDRC gain application circuitry 524 may be configured to apply the gain to the particular frequency band of Enhanced, thereby generating the output of the WDRC circuitry 1212. In other words, the WDRC gain application circuitry 524 may output wdrc_gain*Enhanced for the particular frequency band of Enhanced, where wdrc_gain is the gain determined for the particular frequency band by the WDRC gain lookup circuitry 522.

When there is a low level of speech (e.g., because no one is talking), the level of Enhanced (which should contain only speech and little noise) may be low. In such a situation, because WDRC curves may typically apply high gains to low signal levels, if the WDRC circuitry determines gain based on the level of Enhanced, the WDRC circuitry may select an inappropriately high WDRC gain to apply to Enhanced. This may cause inappropriately high amplification of whatever noise is in Enhanced, thereby undoing the noise reduction that generated Enhanced. Instead, the WDRC circuitry 1212 may be configured to estimate WDRC gains applied to Enhanced (i.e., the predominantly noise-reduced signal) using the level of Input (i.e., the signal prior to noise reduction), while the WDRC circuitry 412-1112 may be configured to estimate WDRC gains applied to Enhanced using a level that is at least a threshold level. This may be helpful, because the level used to estimate WDRC gains applied to Enhanced may be higher than the level of Enhanced when there is a low level of speech, and therefore the WDRC gains may be appropriately lower.

While the above description has described various methods and circuitry for performing WDRC after noise reduction performed using noise reduction circuitry having neural network circuitry, in some embodiments these methods and circuitry may be used after noise reduction performed using other types of noise reduction circuitry.

This disclosure includes, at least, the following examples:

Example A1 is directed to an ear-worn device, comprising: noise reduction circuitry configured to receive an input audio signal and generate an enhanced audio signal comprising a noise-reduced version of the input audio signal; and wide dynamic range compression (WDRC) circuitry comprising: speech level calculation circuitry configured to determine a first level, wherein the first level is calculated based, at least in part, on speech in the input audio signal; level selection circuitry configured to select a level that is: the first level if the first level is greater than a threshold level; and a second level, different from the first level, if the first level is not greater than the threshold level; and WDRC gain circuitry configured to determine a WDRC gain based on the level selected by the level selection circuitry.

Example A2 is directed to the ear-worn device of example A1, wherein the threshold level and the second level are different.

Example A3 is directed to the ear-worn device of example A2, wherein the second level is greater than the threshold level.

Example A4 is directed to the ear-worn device of example A1, wherein the threshold level and the second level are the same.

Example A5 is directed to the ear-worn device of any of examples A1-A4, wherein the threshold level indicates whether speech is present in the input audio signal.

Example A6 is directed to the ear-worn device of any of examples A1-A5, wherein the second level is based, at least in part, on a noise level of the input audio signal.

Example A7 is directed to the ear-worn device of any of examples A1-A6, wherein the threshold level is based, at least in part, on a noise level of the input audio signal.

Example A8 is directed to the ear-worn device of any of examples A1-A7, wherein the threshold level is equal to 40 dB SPL, equal to 60 dB SPL, or between 40 dB SPL and 60 dB SPL.

Example A9 is directed to the ear-worn device of any of examples A1-A8, wherein the second level is based, at least in part, on a previous level of speech in the input audio signal.

Example A10 is directed to the ear-worn device of any of examples A1-A8, wherein the second level is based, at least in part, on a predetermined constant level.

Example A11 is directed to the ear-worn device of example A10, wherein the predetermined constant level is equal to 50 dB SPL, equal to 70 dB SPL, or between 50 dB SPL and 70 dB SPL.

Example A12 is directed to the ear-worn device of any of examples A1-A11, wherein the noise reduction circuitry further comprises neural network circuitry configured to generate one or more neural network outputs based on the input audio signal, and the speech level calculation circuitry is configured to determine the first level based on the one or more neural network outputs.

Example A13 is directed to the ear-worn device of example A12, wherein the one or more neural network outputs comprise a mask that, when applied to the input audio signal, results in a speech component of the input audio signal or a noise component of the input audio signal.

Example A14 is directed to the ear-worn device of any of examples A1-A13, wherein the speech level calculation circuitry is further configured to calibrate the first level.

Example A15 is directed to the ear-worn device of any of examples A1-A14, wherein the level selection calculation circuitry is further configured to smooth the selected level.

Example B1. An ear-worn device comprising: noise reduction circuitry comprising neural network circuitry configured to generate one or more neural network outputs based on a received input audio signal, and wherein the noise reduction circuitry is configured to generate an enhanced audio signal comprising a noise-reduced version of the input audio signal based on the one or more neural network outputs; and wide dynamic range compression (WDRC) circuitry configured to determine a WDRC gain based on a level of the input audio signal and apply the WDRC gain to the enhanced audio signal, thereby generating a WDRC output audio signal.

Example B2 is directed to the ear-worn device of example B1, wherein the WDRC circuitry further comprises level calculation circuitry configured to calculate the level of the input audio signal.

Example B3 is directed to the ear-worn device of any of examples B1-B2, wherein the WDRC circuitry further comprises calibration circuitry configured to calibrate the level of the input audio signal.

Example B4 is directed to the ear-worn device of any of examples B1-B3, wherein the WDRC circuitry further comprises level smoothing circuitry configured to smooth the level of the input audio signal.

Example B5 is directed to the ear-worn device of any of examples B1-B4, wherein the one or more neural network outputs comprise a mask that, when applied to the input audio signal, results in a speech component of the input audio signal or a noise component of the input audio signal.

Example B6 is directed to the ear-worn device of any of examples B1-B5, wherein the noise reduction circuitry further comprises noise gain application circuitry and summing circuitry configured to generate the enhanced audio signal such that the enhanced audio signal comprises the speech component of the input audio signal combined with the noise component of the input audio signal to which has been applied a noise gain.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device, comprising:
noise reduction circuitry configured to receive an input audio signal and generate an enhanced audio signal comprising a noise-reduced version of the input audio signal; and
wide dynamic range compression (WDRC) circuitry comprising:
speech level calculation circuitry configured to determine a first level, wherein the first level is calculated based, at least in part, on speech in the input audio signal;
level selection circuitry configured to select a level that is:
the first level if the first level is greater than a threshold level; and
a second level, different from the first level, if the first level is not greater than the threshold level; and
WDRC gain circuitry configured to determine a WDRC gain based on the level selected by the level selection circuitry.

2. The ear-worn device of claim 1, wherein the threshold level and the second level are different.

3. The ear-worn device of claim 2, wherein the second level is greater than the threshold level.

4. The ear-worn device of claim 1, wherein the threshold level and the second level are the same.

5. The ear-worn device of claim 1, wherein the threshold level indicates whether speech is present in the input audio signal.

6. The ear-worn device of claim 1, wherein the second level is based, at least in part, on a noise level of the input audio signal.

7. The ear-worn device of claim 1, wherein the threshold level is based, at least in part, on a noise level of the input audio signal.

8. The ear-worn device of claim 1, wherein the threshold level is equal to 40 dB SPL, equal to 60 dB SPL, or between 40 dB SPL and 60 dB SPL.

9. The ear-worn device of claim 1, wherein the second level is based, at least in part, on a previous level of speech in the input audio signal.

10. The ear-worn device of claim 1, wherein the second level is based, at least in part, on a predetermined constant level.

11. The ear-worn device of claim 10, wherein the predetermined constant level is equal to 50 dB SPL, equal to 70 dB SPL, or between 50 dB SPL and 70 dB SPL.

12. The ear-worn device of claim 1, wherein the noise reduction circuitry further comprises neural network circuitry configured to generate one or more neural network outputs based on the input audio signal, and the speech level calculation circuitry is configured to determine the first level based on the one or more neural network outputs.

13. The ear-worn device of claim 12, wherein the one or more neural network outputs comprise a mask that, when applied to the input audio signal, results in a speech component of the input audio signal or a noise component of the input audio signal.

14. The ear-worn device of claim 1, wherein the speech level calculation circuitry is further configured to calibrate the first level.

15. The ear-worn device of claim 1, wherein the level selection calculation circuitry is further configured to smooth the selected level.

16. An ear-worn device comprising:
noise reduction circuitry comprising neural network circuitry configured to generate one or more neural network outputs based on a received input audio signal, and wherein the noise reduction circuitry is configured to generate an enhanced audio signal comprising a noise-reduced version of the input audio signal based on the one or more neural network outputs; and
wide dynamic range compression (WDRC) circuitry configured to determine a WDRC gain based on a level of the input audio signal and apply the WDRC gain to the enhanced audio signal, thereby generating a WDRC output audio signal.

17. The ear-worn device of claim 16, wherein the WDRC circuitry further comprises level calculation circuitry configured to calculate the level of the input audio signal.

18. The ear-worn device of claim 16, wherein the WDRC circuitry further comprises calibration circuitry configured to calibrate the level of the input audio signal.

19. The ear-worn device of claim 16, wherein the WDRC circuitry further comprises level smoothing circuitry configured to smooth the level of the input audio signal.

20. The ear-worn device of claim 16, wherein the one or more neural network outputs comprise a mask that, when applied to the input audio signal, results in a speech component of the input audio signal or a noise component of the input audio signal.

21. The ear-worn device of claim 16, wherein the noise reduction circuitry further comprises noise gain application circuitry and summing circuitry configured to generate the enhanced audio signal such that the enhanced audio signal comprises the speech component of the input audio signal combined with the noise component of the input audio signal to which has been applied a noise gain.
